(19) United States
(12) Patent Application Publication
(10) Pub. No.: US 2020/0241570 A1
(43) Pub. Date: Jul. 30, 2020

(54) CONTROL DEVICE, CAMERA DEVICE, FLIGHT BODY, CONTROL METHOD AND PROGRAM

(71) Applicant: SZ DJI TECHNOLOGY CO., LTD., Shenzhen (CN)

(72) Inventor: Takahiko YOSHIDA, Shenzhen (CN)

(21) Appl. No.: 16/850,746

(22) Filed: Apr. 16, 2020

Related U.S. Application Data
(63) Continuation of application No. PCT/CN2018/111495, filed on Oct. 23, 2018.

(30) Foreign Application Priority Data
Oct. 30, 2017 (JP) 2017-209235

(51) Int. Cl. G05D 1/10; H04N 5/232; G03B 37/00; H04N 5/235

(52) U.S. Cl. CPC G05D 1/101; H04N 5/235; G03B 37/00; H04N 5/23203

(57) ABSTRACT

A control device includes a processor and a memory. The memory stores instructions that, when executed by the processor, cause the processor to obtain a height of a camera device with respect to a reference position and, based on the height of the camera device, control an execution frequency for processing parameters used in a white balance adjustment of an image captured by the camera device.

### CROSS-REFERENCE TO RELATED APPLICATIONS

This application is a continuation of International Application No. PCT/CN2018/111495, filed Oct. 23, 2018, which claims priority to Japanese Application No. 2017-209235, filed Oct. 30, 2017, the entire contents of both of which are incorporated herein by reference.

### TECHNICAL FIELD

The present disclosure relates to a control device, a camera device, a flight body, a control method, and a program.

### BACKGROUND

Patent Document 1 describes the use of a control value of an automatic white balance function immediately before a moving period, in which the camera device is determined to be moving, to control the automatic white balance function immediately after the moving period.
Patent Document 1: Japanese Application Laid-Open No. 2015-177420.

### SUMMARY

Embodiments of the present disclosure provide a control device including a processor and a memory. The memory stores instructions that, when executed by the processor, cause the processor to obtain a height of a camera device with respect to a reference position and, based on the height of the camera device, control an execution frequency for processing parameters used in a white balance adjustment of an image captured by the camera device.

Embodiments of the present disclosure also provide a camera device including an image sensor and a control device. The control device includes a processor and a memory. The memory stores instructions that, when executed by the processor, cause the processor to obtain a height of a camera device with respect to a reference position and, based on the height of the camera device, control an execution frequency for processing parameters used in a white balance adjustment of an image captured by the camera device.

Embodiments of the present disclosure also provide a flight body including a propeller and the above-described camera device.

Embodiments of the present disclosure also provide a control method including obtaining a height of a camera device with respect to a reference position and, based on the height of the camera device, controlling an execution frequency for processing parameters used in a white balance adjustment parameter of an image captured by the camera device.

### BRIEF DESCRIPTION OF THE DRAWINGS

FIG. 1 is a schematic diagram of appearance of an unmanned aerial vehicle (UAV) and a remote operation device according to an embodiment of the disclosure.

FIG. 2 is a schematic diagram of functional blocks of a UAV according to an embodiment of the disclosure.

FIG. 3 is a diagram of an example of the relationship between the height of the camera device and a first weight according to an embodiment of the disclosure.

FIG. 4 is a diagram of an example of the relationship between the height of the camera device and a second weight according to an embodiment of the disclosure.

FIG. 5 is a flowchart of an example of a control process of the execution frequency for the automatic white balance according to an embodiment of the disclosure.

FIG. 6 is a diagram showing the hardware configuration according to an embodiment of the disclosure.

### REFERENCE NUMERALS

10 UAV
20 UAV Body
30 UAV Controller
32 Storage Device
36 Communication Interface
40 Propeller
41 GPS Receiver
42 Inertia Measurement Unit
43 Magnetic Compass
44 Barometric Altimeter
45 Temperature Sensor
46 Humidity Sensor
50 Gimbal
60 Camera Device
100 Camera Device
102 Imaging Unit
110 Camera Controller
112 Acquisition Unit
114 Determination Unit
116 Automatic White Balance Control Unit
120 Image Sensor
130 Storage Device
200 Lens Unit
210 Lens
212 Lens Driver
214 Position Sensor
220 Lens Controller
222 Storage Device
300 Remote Operation Device
1200 Computer
1210 Host Controller
1212 CPU
1214 RAM
1220 I/O Controller
1222 Communication Interface
1230 ROM

### DETAILED DESCRIPTION OF THE EMBODIMENTS

Example embodiments of the disclosure will be described below, but the following embodiments do not limit the disclosure. All combinations of features in the embodiments described below are not necessarily required for the solution of the disclosure. Those of ordinary skill in the art can perform various changes or improvements to the following embodiments. All the embodiments with the changes or improvements are within the scope of the present disclosure.

The claims, the specification, the drawings of the specification, and the abstract of the specification contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Various embodiments of the present disclosure can be described with reference to flowcharts or block diagrams. The block diagram expresses (1) stage of a process for operation execution or (2) a functional unit of a device for operation execution. The referred stage or unit can be implemented by a programmable circuit and/or a processor. A special purposed circuit may be a digital and/or analog hardware circuit including an integrated circuit (IC) and/or a discrete circuit. The programmable circuit may include a reconfigurable hardware circuit. The reconfigurable hardware circuit may include logical AND, logical OR, logical XOR, logical NAND, logical NOR, other logical operations, a trigger, a register, a field programmable gate arrays (FPGA), a programmable logic array (PLA), or other storage device.

A computer-readable medium may include any physical device, which can store commands executable by an appropriate device. The commands, stored in the computer-readable medium, can be executed to perform operations specified according to the flowchart or the block diagram. The computer-readable medium may include an electronic storage medium, a magnetic storage medium, an optical storage medium, an electromagnetic storage medium, a semiconductor storage medium, etc. The computer-readable medium may more specifically include a floppy Disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray® disc, memory stick, integrated circuit card, etc.

A computer-readable command may include any one of source code or object code described by any combination of one or more programming languages. The source or object codes include traditional procedural programming languages. The traditional procedural programming languages can be assembly commands, command set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing devices. The processor or the programmable circuit can execute computer-readable commands to be a manner for performing the operations specified in the flowchart or block diagram. The example as the processor includes a computer processor, a processing unit, a microprocessor, a digital signal processor, a controller, a microcontroller, etc.

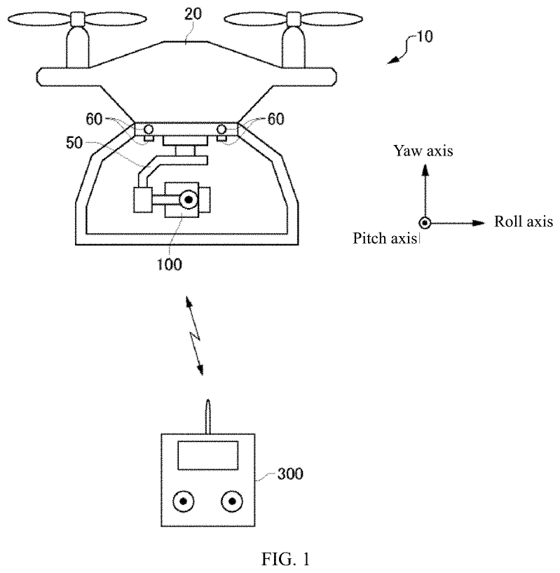

FIG. 1 shows an example of the appearance of an unmanned aerial vehicle (UAV) 10 and a remote operation device 300. The UAV 10 includes a UAV body 20, a gimbal 50, a plurality of camera devices 60, and a camera device 100. The gimbal 50 and the camera device 100 are an example of a camera system. The UAV 10 is an example of a flight body movable in the air. In some other embodiments, the flight body can include another body movable in the air, such as another aircraft, an airship, or a helicopter, etc.

The UAV body 20 includes a plurality of rotors. The plurality of rotors are an example of a propeller. The UAV body 20 controls the rotation of the plurality of rotors to cause the UAV 10 to fly. The UAV body 20 includes, e.g., four rotors to cause the UAV 10 to fly. The number of rotors is not limited to four. In some embodiments, the UAV 10 may be a fixed-wing aircraft without rotors.

The camera device 100 can include a camera that captures images of an object in a desired imaging range. The gimbal 50 can rotatably support the camera device 100. The gimbal 50 is an example of a supporting structure. For example, the gimbal 50 uses an actuator to rotatably support the camera device 100 around a pitch axis. The gimbal 50 uses actuators to further rotatably support the camera device 100 around a roll axis and a yaw axis. The gimbal 50 can change an attitude of the camera device 100 by rotating the camera device 100 around at least one of the yaw axis, the pitch axis, or the roll axis.

The plurality of cameras devices 60 are sensory cameras to capture images of the surroundings of the UAV 10 to control the flight of the UAV 10. Two camera devices 60 can be arranged at the front of the UAV 10. Other two camera devices 60 can be arranged at the bottom of the UAV 10. The two camera devices 60 at the front can be paired to function as a stereo camera. The two camera devices 60 at the bottom can also be paired to function as a stereo camera. 3D spatial data of the UAV 10 surroundings can be generated based on the images captured by the plurality of camera devices 60. The number of the camera devices 60 at the UAV 10 is not limited to four, as long as the UAV 10 includes at least one camera device 60. The UAV 10 can also have at least one camera device 60 at each of the head, the back, the side, the bottom, and the top of the UAV 10. A settable angle of view of the camera device 60 may be greater than a settable angle of view of the camera device 100. The camera device 60 may have a single focus lens or a fisheye lens.

A remote operation device 300 communicates with the UAV 10 to remotely operate the UAV 10. The remote operation device 300 can wirelessly communicate with the UAV 10. The remote operation device 300 sends instruction information of various commands related to movements of the UAV 10 such as ascending, descending, acceleration, deceleration, moving forward, moving backward, turning, etc. The instruction information includes, e.g., instruction information to increase the height of the UAV 10. The instruction information can indicate the height at which the UAV 10 should be at. The UAV 10 moves to the height indicated by the instruction information received from the remote operation device 300. The instruction information may include an ascending command to raise the UAV 10. The UAV 10 rises while receiving the ascending command. When the height of the UAV 10 has reached the upper limit, the UAV 10 can be limited to rise even though the UAV 10 receives the ascending command.

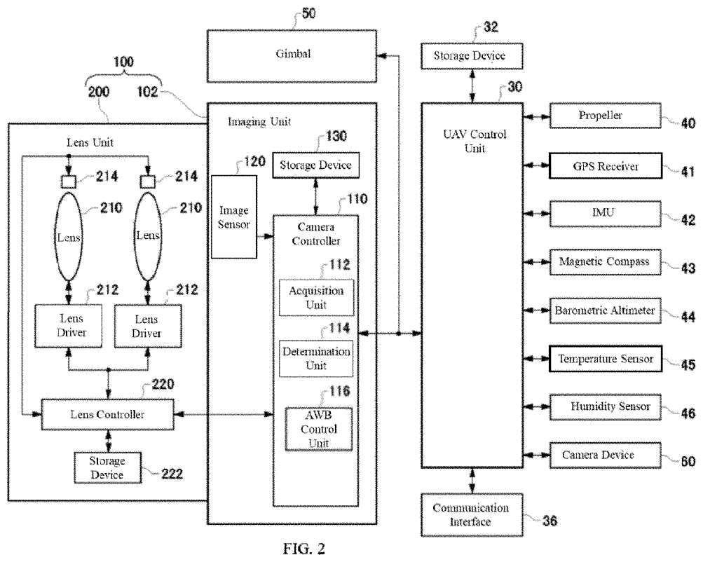

FIG. 2 shows an example of functional blocks of the UAV 10. The UAV 10 includes a UAV controller 30, a storage device 32, a communication interface 36, a propeller 40, a GPS receiver 41, an inertia measurement unit (IMU) 42, a magnetic compass 43, a barometric altimeter 44, a temperature sensor 45, a humidity sensor 46, the gimbal 50, the camera device 60, and the camera device 100.

The communication interface 36 is configured to communicate with the remote operation device 300 or other devices. The communication interface 36 can receive the instruction information of, e.g., various commands for the UAV controller 30 from the remote operation device 300. The storage device 32 stores programs for the UAV controller 30 to control the propeller 40, the GPS receiver 41, the inertial measurement device (IMU) 42, the magnetic compass 43, the barometric altimeter 44, the temperature sensor 45, the humidity sensor 46, the gimbal 50, the camera device 60, and the camera device 100. The storage device 32 may include a computer-readable storage medium, such as at least one of SRAM, DRAM, EPROM, EEPROM, or flash memory such as USB drive. The storage device 32 may be arranged inside the UAV body 20. The storage device 32 can be configured to be detachable from the UAV body 20.

The UAV controller 30 controls the flight or photographing of the UAV 10 according to the programs stored in the storage device 32. The UAV controller 30 may include a central processing unit (CPU), a microprocessor such as a micro processing unit (MPU), or a microcontroller such as a micro control unit (MCU). The UAV controller 30 controls the flight and photographing of the UAV 10 according to the commands received from the remote operation device 300 via the communication interface 36. The propeller 40 propels the UAV 10. The propeller 40 includes the plurality of rotors and a plurality of drive motors that rotate the plurality of rotors. The propeller 40 rotates the plurality of rotors through a plurality of drive motors according to the commands from the UAV controller 30 to cause the UAV 10 to fly.

The GPS receiver 41 receives a plurality of signals indicating times of transmission from a plurality of GPS satellites. The GPS receiver 41 calculates the position (latitude and longitude) of the GPS receiver 41, the position (latitude and longitude) of the UAV 10, based on the received plurality of signals. The IMU 42 detects an attitude of the UAV 10. The IMU 42 detects accelerations in three axial directions of front/back, left/right, and up/down as well as angular velocities in three axial directions of the pitch axis, the roll axis, and the yaw axis, which are used as the attitude of the UAV 10. The magnetic compass 43 detects the direction of the head of the UAV 10. The barometric altimeter 44 detects a flight altitude of the UAV 10. The barometric altimeter 44 detects the air pressure around the UAV 10 and converts the detected air pressure into an altitude to detect the altitude. The temperature sensor 45 detects the temperature around the UAV 10. The humidity sensor 46 detects humidity around the UAV 10.

The camera device 100 includes an imaging unit 102 and a lens unit 200. The lens unit 200 is an example of a lens device. The imaging unit 102 includes an image sensor 120, a camera controller 110, and a storage device 130. The image sensor 120 may include a charge-coupled device (CCD) or a complementary metal-oxide-semiconductor (CMOS) sensor. The image sensor 120 captures an optical image formed through the plurality of lenses 210 and outputs the captured image data to the camera controller 110. The camera controller 110 may include a CPU, a microprocessor such as an MPU, or a microcontroller such as an MCU. The camera controller 110 may control the camera device 100 based on an operation command of the camera device 100 from the UAV controller 30. The storage device 130 may include a computer-readable storage medium, such as at least one of SRAM, DRAM, EPROM, EEPROM, or flash memory such as USB drive. The storage device 130 stores programs for the camera controller 110 to control the image sensor 120, etc. The storage device 130 may be arranged inside a frame of the camera device 100. The storage device 130 may be detachable from the frame of the camera device 100.

The lens unit 200 includes a plurality of lenses 210, a plurality of lens driver 212, and a lens controller 220. The plurality of lenses 210 can function as zoom lenses, manual zoom lenses, or focus lenses. At least some or all of the plurality of lenses 210 are configured to be able to move along an optical axis. The lens unit 200 may be an interchangeable lens configured to be detachable from the imaging unit 102. The lens driver 212 moves at least some or all of the plurality of lenses 210 along the optical axis via a mechanism component such as a cam ring. The lens driver 212 may include an actuator. The actuator may include a step motor. The lens controller 220 drives the lens driver 212 according to a lens control command from the imaging unit 102 to move one or more lenses 210 in the optical axis direction via the mechanism component. The lens control command is, for example, a zoom control command or a focus control command.

The lens unit 200 also includes a storage device 222 and a position sensor 214. The lens controller 220 controls the lens driver 212 to move the lens 210 in the optical axis direction according to a lens operation command from the imaging unit 102. Some or all of the lenses 210 moves along the optical axis. The lens controller 220 moves at least one of the lenses 210 along the optical axis to perform at least one of a zooming operation or a focusing operation. The position sensor 214 detects the position of the lens 210. The position sensor 214 can detect a current zoom position or focus position.

The lens driver 212 may include a vibration correction mechanism. The lens controller 220 may perform the vibration correction by moving the lens 210 in the optical axis direction or a direction perpendicular to the optical axis through the vibration correction mechanism. The lens driver 212 may perform the vibration correction by driving the vibration correction mechanism with the step motor. In some embodiments, the vibration correction mechanism may be driven by a step motor to move the image sensor 120 in the optical axis direction or in a direction perpendicular to the optical axis to perform vibration correction.

The storage device 222 stores control values of the plurality of lenses 210 driven by the lens driver 212. The storage device 222 may include at least one of SRAM, DRAM, EPROM, EEPROM, or flash memories such as USB flash drive.

In the camera device 100, the camera controller 110 includes an automatic white balance (AWB) control unit 116 that executes the AWB process. The AWB control unit 116 specifies an area that should be white in an image captured by the image sensor 120 according to a predetermined condition. Based on pixel values of R, G, and B components in the specified area, the AWB control unit 116 derives white balance control values that represent the individual gains suitable for R component, G component, and B component of the image output by the image sensor 120. The AWB control unit 116 derives the individual control values for R component, G component, and B component to adjust the white balance for the image captured by the image sensor 120. A series of processes to derive the white balance control values is an example of a process to determine a parameter to adjust the white balance of an image captured by the camera device 100. The white balance control value is derived according to a type of a light source while the camera device 100 is photographing. Therefore, the process to determine the parameter to adjust the white balance may be a series of processes to determine the type of the light source while the camera device 100 is photographing based on the image captured by the camera device 100.

Because of different photographing environments of the camera device 100, it may be possible that the white balance of the image captured by the camera device 100 may not be adjusted properly according to the frequency of the white balance adjustment. Because of different altitudes of the camera device 100, it may be possible that the white balance of the image captured by the camera device 100 may not be adjusted properly according to the frequency of the white balance adjustment. For example, the environment in which the camera device 100 carried by a flight object, such as the UAV 10, photographs varies greatly depending on the flight environment of the flight object. Because of the different flight environments, it may be possible that the white balance of the image captured by the camera device 100 may not be properly adjusted.

When the color value of an image captured by the camera device 100 has a relatively large change with time, compared to when the color value have a smaller change with time, if the frequency of the balance adjustment is relative high, the white balance more likely may not be properly adjusted.

When the height of the camera device 100 carried by a flight object, such as the UAV 10, from a reference position at a reference surface, such as the ground, is relative large, i.e., the height of the UAV 10 is large, the images captured by the camera device 100 are mostly landscapes. When the height of the UAV 10 is large, the color value of the image tends to have a smaller change with time. On the other hand, when the height of the camera device 100 from a reference position at a reference surface, such as the ground, is small, the color value of the image tends to have a larger change with time.

In some embodiments, when the speed of the camera device 100 carried by a flight object such as the UAV 10 is relative high, i.e., the speed of the UAV 10 is relative high, the color value of the image captured by the camera device 100 tends to have a larger change with time. On the other hand, when the speed of the UAV 10 is relatively low, the color value of the image captured by the camera device 100 tends to have a smaller change with time.

When the color value of the image has a smaller change with time, even though the frequency of the white balance adjustment is relatively high, the white balance of the image captured by the camera device 100 tends to be adjusted properly. When the white balance is properly adjusted, for example, a flicker of a moving image captured by the camera device 100 can be suppressed. On the other hand, when the color value of the image has a larger change with time, if the frequency of the white balance adjustment is relatively high, the white balance of the image captured by the imaging device 100 may not be adjusted properly. When the white balance is not adjusted properly, for example, a moving image captured by the camera device 100 may flick.

In some embodiments, the frequency of the white balance adjustment is reduced, when the color value of the image captured by the camera device 100 has a larger change with time determined based on the height of the camera device 100 and the speed of the camera device 100.

To control the frequency of the white balance adjustment, the camera controller 110 also includes an acquisition unit 112 and a determination unit 114. The acquisition unit 112 acquires height information indicating the height of the camera device 100 from the reference position. The reference position may be a position at a predetermined reference plane. The reference position may be an intersection of a straight line extending in the vertical direction from the camera device 100 or the UAV 10 and a reference plane. The reference position may be the intersection of a straight line extending in a vertical direction from a predetermined point such as the center of gravity of the camera device 100 or the UAV 10 and the reference plane. The reference surface may be, for example, the take-off surface of the UAV 10 such as the ground, the sea surface, the floor surface, or the roof surface, or the surface on which the subject photographed by the camera device 100 is located. The acquisition unit 112 can acquire the height information indicating the height of the camera device 100 from the ground. The UAV 10 may have an infrared sensor that detects the distance from the ground. The infrared sensor is arranged at the UAV 10 and configured to face downward in a vertical direction. The infrared sensor radiates infrared light downward in the extending direction and receives reflected light to detect the distance from the UAV 10 to the ground. The acquisition unit 112 may acquire the information indicating the distance from the UAV 10 to the ground detected by the infrared sensor, as the height information indicating the height of the camera device 100 from the reference position.

The acquisition unit 112 also acquires the speed information indicating the speed of the camera device 100. The acquisition unit 112 may acquire the speed information indicating the speed of the UAV 10 from the UAV controller 30 as the speed information indicating the speed of the camera device 100.

Based on the height of the camera device 100 and the speed of the camera device 100, the determination unit 114 determines an execution frequency of a process to determine the parameter for adjusting the white balance. Based on the height of the camera device 100 and the speed of the camera device 100, the determination unit 114 may determine the number of executions per unit time of the process to determine the parameter for adjusting the white balance as the execution frequency. The determination unit 114 may determine the execution frequency as a first execution frequency, when the height indicated by the height information is a first height. The determination unit 114 may determine the execution frequency as a second execution frequency higher than the first execution frequency when the height indicated by the height information is a second height higher than the first height.

The determination unit 114 may determine a first weight based on the height indicated by the height information. The determination unit 114 may determine a second weight based on the speed indicated by the speed information. The determination unit 114 may determine the execution frequency based on the first weight and the second weight.

When the height indicated by the height information is the first height h₁, the determination unit 114 may determine the first weight W₁(hₙ) as W₁(h₁). When the height indicated by the height information is a second height h₂ greater than the first height h₁, the determination unit 114 may determine the first weight W₁(hₙ) as W₁(h₂) greater than W₁(h₁).

When the speed indicated by the speed information is the first speed v₁, the determination unit 114 may determine the second weight W₂(vₙ) as W₂(v₁). When the speed of the camera device is a second speed v₂ higher than the first speed v₁, the determination unit 114 may determine the second weight W₂(vₙ) as W₂(v₂) which is smaller than W₂(v₁).

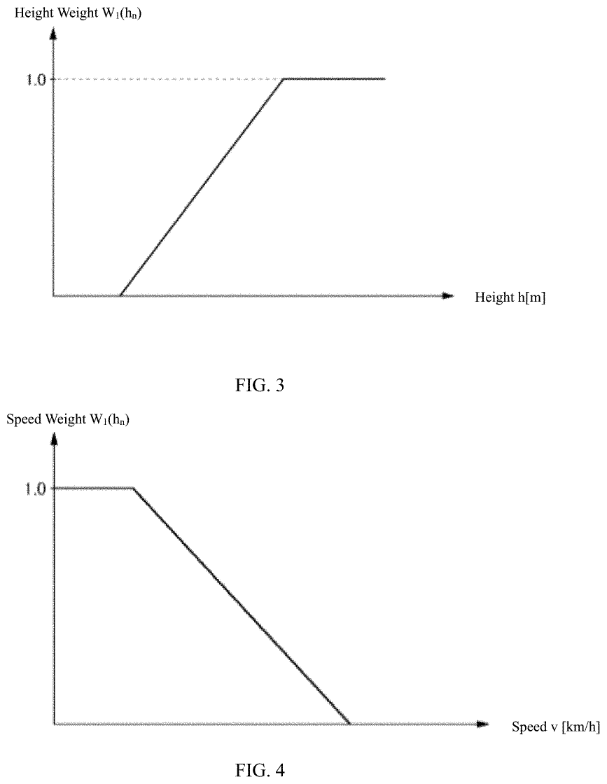

The determination unit 114 may determine the first weight W₁(hₙ) corresponding to the height of the camera device 100 according to a function indicating the relationship between the height of the camera device 100 and the first weight W₁(hₙ) shown in FIG. 3. The determination unit 114 may determine the second weight W₂(vₙ) corresponding to the speed of the camera device 100 according to a function indicating the relationship between the speed of the camera device 100 and the second weight W₂(vₙ) shown in FIG. 4.

The determination unit 114 can calculate the weight W based on the sum of the first weight W₁(hₙ) and the second weight W₂(vₙ). The maximum value of the weight W is 1.0, that is, the determination unit 114 can calculate the weight W based on W=Min(W₁(hₙ)+W₂(vₙ), 1.0).

For example, a reference number of executions of AWB, also referred to as a “reference AWB execution number” or simply a “reference execution number,” in X seconds is Y. The reference number of executions can be set to an arbitrary number according to a specification of the camera device 100. The reference number of executions may be, for example, two or three times per second. In some embodiments, the reference number of executions may be sixty times per second. The determination section 114 determines the number of executions of AWB, also referred to as an “AWB execution number” or simply an “execution number,” based on the reference number of executions Y and the weight W. The determination unit 114 determines the number of executions based on: Number of Executions=INT(Y×W). When INT(Y×W)<1, the determination unit 114 determines the number of the executions as one. That is, the determination unit 114 determines the number of the executions so that at minimum the AWB is executed once in X seconds.

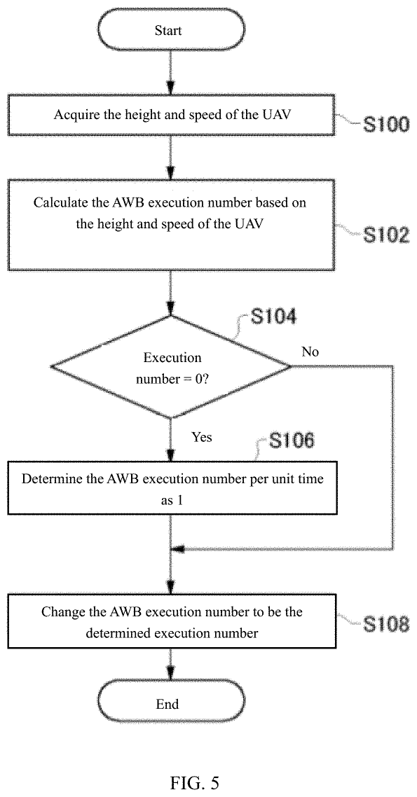

FIG. 5 is a flowchart of an example of the control process of the execution frequency for the automatic white balance consistent with an embodiment of the disclosure.

The acquisition unit 112 acquires information indicating the height and speed of the UAV 10 as the height information and the speed information of the camera device 100 (S100). The determination unit 114 calculates a number of times for executing the AWB, also referred to as an AWB execution number, based on the height and speed of the UAV 10 (S102). The determination unit 114 may determine the first weight W₁(hₙ) based on the height of the UAV 10 and the second weight W₂(vₙ) based on the speed of the UAV 10 according to the functions shown in FIG. 3 and FIG. 4. The determination unit 114 may calculate the AWB execution number by multiplying the predetermined execution number per unit time by the weight W that is the sum of the first weight W₁(hₙ) and the second weight W₂(vₙ). The determination unit 114 determines whether the calculated execution number is 0, that is, whether the calculated execution number is less than 1 (S104). If the calculated execution number is 0, the determination unit 114 determines the AWB execution number per unit time as one (S106). If the calculated execution number is more than one, the determination unit 114 determines the AWB execution number per unit time to be the calculated execution number. The AWB control unit 116 changes the AWB execution number to be the determined execution number (S108). The AWB control unit 116 sequentially adjusts the white balance according to the changed execution number.

In some embodiments, the camera device 100 controls the frequency of the white balance adjustment based on the height of the camera device 100 and the speed of the camera device 100. Based on the height of the camera device 100 and the speed of the camera device 100, the frequency of the white balance adjustment is reduced when the color value of the image captured by the camera device 100 is determined to have a relatively large change with time. Based on the height of the camera device 100 and the speed of the camera device 100, the frequency of the white balance adjustment is increased when the color value of the image captured by the camera device 100 is determined to have a relatively small change with time. Therefore, for example, the flicker of the moving image captured by the camera device 100 can be prevented by properly adjusting the white balance.

The camera controller 110 may further use the distance from the photographed subject as an index to indicate the change of the color value of the image with time. The acquisition unit 112 acquires the determined distance of the photographed subject from the imaging device 100 according to a predetermined condition. The determination unit 114 determines the third weight W₃(Lₙ) based on the acquired distance. For example, when the distance L from the subject is a first distance L₁, the determination unit 114 determines the third weight W₃(Lₙ) as W₃(L₁). When the distance L is a second distance L₂ longer than the first distance L₁, the determination section 114 may determine the third weight W₃(Lₙ) as W₃(L₂) greater than W₃(L₁). In some embodiments, the determination unit 114 may determine the AWB execution number by multiplying the total weight W of the first weight W₁(hₙ), the second weight W₂(vₙ), and the third weight W₃(Lₙ) by the reference AWB execution number.

The camera controller 110 may further use the change amount in the color value of the image as an index to indicate the change of the color value of the image with time. The determination unit 114 may calculate the change amount in the color value of the image according to the difference between the average value of the color value of the predetermined area of the image in the current frame and the average value of the color value of the predetermined area of the image in the previous frame. In some embodiments, the determination unit 114 may calculate a fourth weight W₄(Cₙ), so that the larger the change amount in the color value of the image is, the smaller the AWB execution number is. For example, when the change amount Cₙ of the color value is C₁, the determination unit 114 may determine the fourth weight W₄(Cₙ) as W₄(C₁). When the change amount Cₙ of the color value is C₂ greater than C₁, the determination unit 114 may determine the fourth weight W₄(Cₙ) as W₄(C₂) smaller than W₄(C₁). The determination unit 114 may determine the AWB execution number by multiplying the total weight W of the first weight W₁(hₙ), the second weight W₂(vₙ), and the fourth weight W₄(Cₙ) by the reference AWB execution number. The determination unit 114 may determine the AWB execution number by multiplying the total weight W of the first weight W₁(hₙ), the second weight W₂(vₙ), the third weight W₃(Lₙ), and the fourth weight W₄(Cₙ) by the reference AWB execution number.

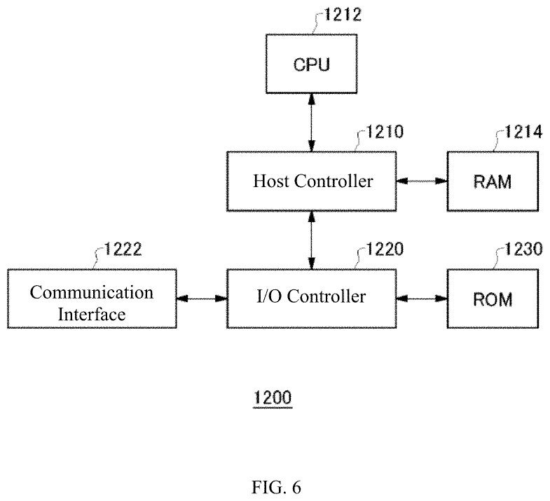

FIG. 6 shows an example of a computer 1200 that can fully or partially implement a plurality of methods of the present disclosure. The program installed on the computer 1200 enables the computer 1200 to function as an operation associated with a device according to an embodiment of the present disclosure or one or more “units” of the device. In some embodiments, the program enables the computer 1200 to execute the operation or to be the one or more “units.” This program enables the computer 1200 to execute a process or a stage of the process according to an embodiment of the present disclosure. The program may be executed by the CPU 1212 to enable the computer 1200 to execute specified operations associated with some or all of the blocks in the flowcharts or block diagrams described in the specification.

As shown in FIG. 6, the computer 1200 includes a CPU 1212 and a RAM 1214, which are connected to each other through a host controller 1210. The computer 1200 also includes a communication interface 1222, and an input/output (I/O) unit, and they are connected to the host controller 1210 through an I/O controller 1220. The computer 1200 also includes a ROM 1230. The CPU 1212 operates according to programs stored in the ROM 1230 or the RAM 1214 to control each unit.

The communication interface 1222 communicates with other electronic devices through a network. The hard drive can store programs and data used by the CPU 1212 of the computer 1200. The ROM 1230 stores a boot program, etc., executed by the computer 1200 during operation, and/or a program that depends on the hardware of the computer 1200. The program is provided through a computer-readable storage medium such as a CR-ROM, a USB flash drive, or an IC card, or a network. The program is installed in a computer-readable recording medium such as the RAM 1214 or the ROM 1230 and is executed by the CPU 1212. The information processing coded in the program is read by the computer 1200 and causes the cooperation between the program and the above-mentioned various types of the hardware resources. The device or method can be constituted through operations or processes, which realize the operation of the information with the use of the computer 1200.

For example, when the computer 1200 communicates with an external device, the CPU 1212 may execute a communication program loaded in the RAM 1214 and instruct the communication interface 1222 to perform communication processing based on the processing coded in the communication program. The CPU 1212 controls the communication interface 1222 to read the transmission data stored in a transmission buffer provided by a storage medium such as the RAM 1214 or the USB flash drive, and sends the read transmission data to the network, or writes received data from the network to a receive buffer, etc., provided by the storage medium.

In some embodiments, the CPU 1212 can enable the RAM 1214 to read all or required portions of a file or database stored in an external storage medium such as a USB flash drive, and perform various types of processing on the data of the RAM 1214. The CPU 1212 can write the processed data back to the external storage medium.

Various types of information such as various types of programs, data, tables, or databases may be stored in a storage medium and subjected to information processing. For the data read from the RAM 1214, the CPU 1212 can perform various types of processing, including various operations, information processing, conditional judgment, conditional transfer, unconditional transfer, information retrieval/replacement, etc., specified by a command sequence of the program, and write results back to the RAM 1214. In some embodiments, the CPU 1212 can retrieve information in files, databases, etc. in the storage medium. For example, when a plurality of entries of an attribute value of a first attribute respectively associated with an attribute value of a second attribute are stored in the storage medium, the CPU 1212 may retrieve the entry matching the attribute value of the first attribute from the plurality of entries and read the attribute value of the second attribute stored in the entry to obtain the attribute of the second attribute associated with the first attribute that satisfies the predetermined condition.

The programs or software units described above may be stored on the computer 1200 or a computer-readable storage medium near the computer 1200. In some embodiments, the storage medium such as a hard drive or a RAM provided in a server system connected to a special purpose communication network or the Internet can be configured as a computer-readable storage medium, so that the program can be provided to the computer 1200 through the network.

In the claims, the specifications, or the reference drawings, the execution order of the various processes such as the operation, the sequence, steps, stages, etc., in the devices, systems, programs, or methods can be implemented with any sequence, unless specifically described as “before . . . ,” “in advance,” etc., and as long as the output of the previous process is not used in a subsequent process. Regarding the operation flow in the claims, the description, or the reference drawings of the description, “first,” “next,” etc., have been used in description for convenience, but the implementation in the order is not necessary.

The respective embodiments are merely used to describe the technical solution of the disclosure but not used to limit the disclosure. Those of ordinary skill in the art should understand that it is still possible to modify and improve the technical solutions in the embodiments. However, the embodiments with these modifications or improvements are within the scope of the disclosure.

What is claimed is:

1. A control device comprising:
a processor; and
a memory storing instructions that, when executed by the processor, cause the processor to:
obtain a height of a camera device with respect to a reference position; and
control, based on the height of the camera device, an execution frequency for processing parameters used in a white balance adjustment of an image captured by the camera device.

2. The control device of claim 1, wherein the instructions further cause the processor to:
obtain a speed of the camera device; and
control the execution frequency based on the height and the speed of the camera device.

3. The control device of claim 2, wherein the instructions further cause the processor to:
determine a first weight based on the height of the camera device;
determine a second weight based on the speed of the camera device; and
determine the execution frequency based on the first weight and the second weight.

4. The control device of claim 3, wherein the instructions further cause the processor to:
determine the first weight to be a first value in response to the height of the camera device being a first height;
determine the first weight to be a second value larger than the first value in response to the height of the camera device being a second height greater than the first height;
determine the second weight to be a third value in response to the speed of the camera device being a first speed; and
determine the second weight to be a fourth value smaller than the third value in response to the speed of the camera device being a second speed higher than the first speed.

5. The control device of claim 1, wherein the instructions further cause the processor to:
control the execution frequency to be a first execution frequency in response to the height of the camera device being a first height; and
control the execution frequency to be a second execution frequency higher than the first execution frequency in response to the height of the camera device being a second height greater than the first height.

6. A camera device comprising:
an image sensor; and
a control device, including:
a processor; and
a memory storing instructions that, when executed by the processor, cause the processor to:
obtain a height of the camera device with respect to a reference position; and
control, based on the height of the camera device, an execution frequency for processing parameters used in a white balance adjustment of an image captured by the image sensor.

7. The camera device of claim 6, wherein the instructions further cause the processor to:
obtain a speed of the camera device; and
control the execution frequency based on the height and the speed of the camera device.

8. The camera device of claim 7, wherein the instructions further cause the processor to:
determine a first weight based on the height of the camera device;
determine a second weight based on the speed of the camera device; and
determine the execution frequency based on the first weight and the second weight.

9. The camera device of claim 8, wherein the instructions further cause the processor to:
determine the first weight to be a first value in response to the height of the camera device being a first height;
determine the first weight to be a second value larger than the first value in response to the height of the camera device being a second height greater than the first height;
determine the second weight to be a third value in response to the speed of the camera device being a first speed; and
determine the second weight to be a fourth value smaller than the third value in response to the speed of the camera device being a second speed higher than the first speed.

10. The camera device of claim 6, wherein the instructions further cause the processor to:
control the execution frequency to be a first execution frequency in response to the height of the camera device being a first height; and
control the execution frequency to be a second execution frequency higher than the first execution frequency in response to the height of the camera device being a second height greater than the first height.

11. The camera device of claim 6, wherein the image sensor includes a charge-coupled device (CCD) or a complementary metal-oxide-semiconductor (CMOS) sensor.

12. The camera device of claim 6, further comprising:
at least one lens;
wherein the image sensor is configured to capture the image through the at least one lens.

13. The camera device of claim 12, further comprising:
a lens driver configured to drive the at least one lens.

14. A flight body comprising:
a propeller; and
the camera device of claim 6.

15. A control method comprising:
obtaining a height of a camera device with respect to a reference position; and
controlling, based on the height of the camera device, an execution frequency for processing parameters used in a white balance adjustment parameter of an image captured by the camera device.

16. The method of claim 15, further comprising:
obtaining a speed of the camera device; and
controlling the execution frequency based on the height and the speed of the camera device.

17. The method of claim 16, further comprising:
determining a first weight based on the height of the camera device; and
determining a second weight based on the speed of the camera device;
wherein determining the execution frequency includes determining the execution frequency based on the first weight and the second weight.

18. The method of claim 17, wherein:
determining the first weight based on the height of the camera device includes:
determining the first weight to be a first value in response to the height of the camera device being a first height; and
determining the first weight to be a second value larger than the first value in response to the height of the camera device being a second height greater than the first height; and
determining the second weight based on the speed of the camera device includes:
determining the second weight to be a third value in response to the speed of the camera device being a first speed; and
determining the second weight to be a fourth value smaller than the third value in response to the speed of the camera device being a second speed higher than the first speed.

19. The method of claim 15, wherein controlling the execution frequency based on the height of the camera device includes:
controlling the execution frequency to be a first execution frequency in response to the height of the camera device being a first height; and
controlling the execution frequency to be a second execution frequency higher than the first execution frequency in response to the height of the camera device being a second height greater than the first height.

20. The method of claim 15, wherein obtaining the height of the camera device with respect to the reference position includes:
obtaining a distance from the camera device to a ground by use of an infrared sensor.
